(19) United States
(12) Patent Application Publication
(10) Pub. No.: US 2005/0040180 A1
(43) Pub. Date: Feb. 24, 2005

(54) Frontal extraction means for a vending machine

(76) Inventor: Sang K. Sheem, Pleasanton, CA (US)

Correspondence Address: SANG K. SHEEM, 1790 PASEO DEL CAJON, PLEASANTON, CA, 94566, US

(21) Appl. No.: 10/646,877

(22) Filed: Aug. 21, 2003

(51) Int. Cl. B65H 3/44; G07F 11/00; B65G 59/00

(52) U.S. Cl. 221/124

(57) ABSTRACT

This patent application teaches a vending mechanism that can extract items of varying shapes and sizes, and yet can be built at a reasonable cost. A lifting-arm is located in the frontal area of the display shelf. It lifts up the front-most item over a barrier or display-stop so as to cause the item to topple over the shelf-stop and drop. This mechanism is especially useful and economical when one lifting-arm is moveable across the shelf, serving many vending columns of products on the shelf.

### NOTE

This invention disclosure is a divisional-in-part patent application of the prior application Ser. No. 10/364,185, titled, “Vending machine with a ‘Walking Item-Selector’, and methods of using it”.

### TECHNICAL FIELD

This invention relates to self-service merchandise vending machines.

### BACKGROUND ART

As described in the patent application Ser. No. 10/364,185, titled, “Vending machine with a ‘Walking Item-Selector’, and methods of using it”, it is desirable to establish a stand-alone self-service retail store in a form of a large-capacity vending machine.

One difficulty with the conventional vending machine is the limitation in the shapes and sizes of items that one machine can handle. A rotating spiral that is limited to the vending of candies or the likes, and flip-flop gate that is limited to the vending of soda bottles. Some mechanism is more universal but is impractically expensive and enormously complex.

### SUMMARY OF THE INVENTION

Accordingly, it is the objective of this patent application to devise a vending mechanism that can extract items of varying shapes and sizes, from a bar of candy to a jog of one-gallon milk and a bag of charcoal, and that is still reasonable in manufacturing cost.

This objective is achieved by providing a lifting-arm in the front area of the display shelf. The lifting arm lifts up an item-to-be-extracted, causing it to topple over a barrier or shelf-stop.

This lifting arm would be especially useful and would reduce the manufacturing cost when it is incorporated into the embodiment taught in the patent application Ser. No. 10/364,185, titled, “Vending machine with a ‘Walking Item-Selector’, and methods of using it”.

Various means and methods will be described.

### BRIEF DESCRIPTION OF DRAWINGS

FIG. 1 depicts the basic vending mechanism of the present invention.

FIG. 2 shows one example of the embodiments that employs the vending mechanism as shown in FIG. 1.

FIG. 3 shows the same as shown in FIG. 2, except that one travelling-arm, instead of many static ones, is serving a plurality of the vending columns.

FIG. 4 shows that the reach of the arm is too long for thin items.

FIG. 5 shows a remedial feature to correct the problem depicted in FIG. 4.

FIG. 6 shows the embodiments of FIG. 5 in a prospective view.

FIG. 7 shows the plan view of the embodiments of FIG. 5 and FIG. 6.

FIG. 8 shows oversized items being stabilized by a sliding rail.

FIG. 9 shows another example where such a sliding support can be helpful.

FIG. 10 shows a packaged item with a sliding rod attached across the body.

FIG. 11 shows the item of FIG. 10 being stabilized by a supporting rail.

FIG. 12 shows a pushing-weight with a wedged front surface for stabilizing oversized items.

FIG. 13 shows an economic way to fabricate the desired embodiment.

### DETAILED DESCRIPTION

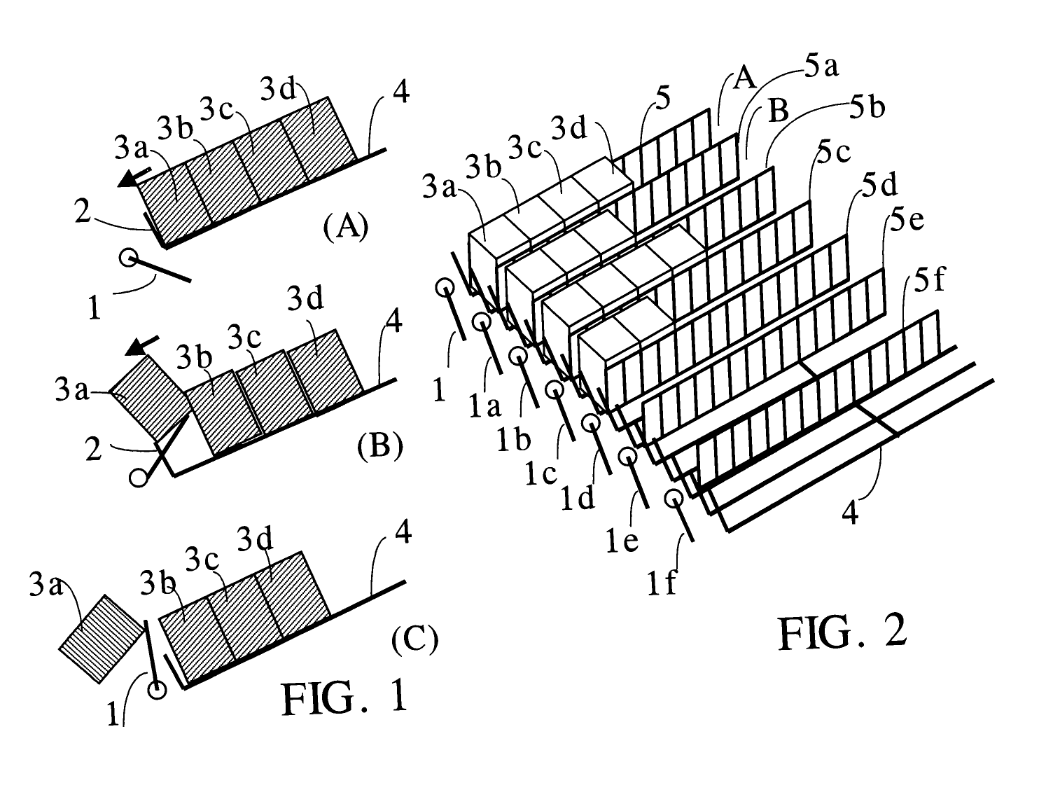

FIG. 1 depicts the basic vending extraction mechanism of the present invention.

FIG. 2 shows a schematic view of a vending shelf that employs the extracting mechanism depicted in FIG. 1.

The item-extraction mechanism comprises a lifting-arm 1 and a shelf-stop 2 at the end.

The front-most item 3a (See FIG. 1(A)) is lifted up and is toppledd over the shelf-stop 2 (See FIG. 1(C)).

The lifting-arm would be activated by a machine such as a motor or the likes when a vending command reaches the machine.

It will be helpful if the lifted item 3a is under a forwardly force (represented by an arrow above the items in FIG. 1) so that the lifted item 3a is pushed over the shelf-stop 2 more easily. If this force is substantial, the item 3a would be toppled over the shelf-stop 2 even before the item 3a is cleared the top of the shelf-stop 2.

The forwardly force also helps preventing the front-most item from being toppled over the shelf-stop 2 and drop by itself In this case the height of the shelf-front 2 may be relatively low as compared to the height of the item 3a to be extracted. This reduces the length of the lifting-arm, thus saving the overall space needed for the swing motion.

The forwardly force may be created by a tilt of the shelf 4 as indicated, or by a spring force or the likes.

(Below will be introduced in FIG. 4 a pushing-weight 7a and 7b that increases the forwardly force substantially.)

The shelf 5 may have column dividers 5, 5a, 5b, . . . , 5g. The column dividers would make the extraction process more efficiently by preventing the item 3a from being strayed into the side instead of being toppled over forwardly.

FIG. 2 shows a plurality of lifting-arms 1, 1a, 1b, . . . , 1f, that is, one lifting-arm for each of the vending column (A, B, . . . ).

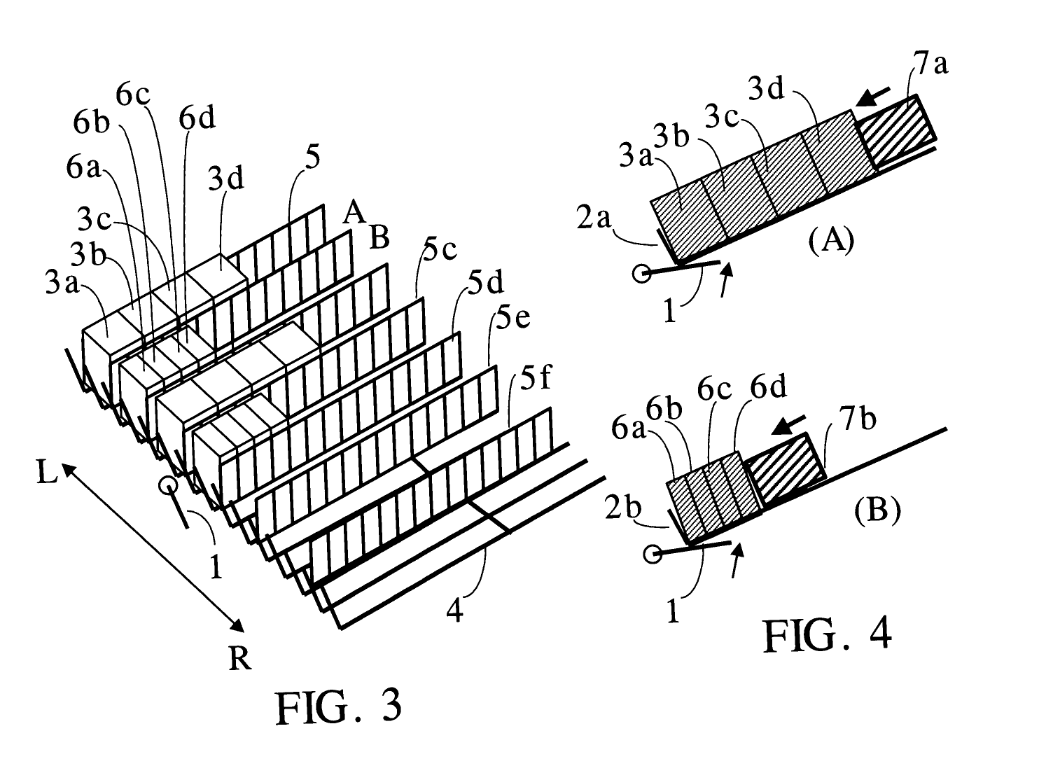

FIG. 3 shows the same as shown in FIG. 2, except that one arm 1 is supposed to serve a plurality of the vending columns, traveling to the left or to the right along the direction indicated by the double-headed arrow L-R.

This moveable feature makes the present patent application a divisional patent-in-part of the prior patent application Ser. No. 10/364,185, titled, “Vending machine with a ‘Walking Item-Selector’, and methods of using it”.

When there are many vending columns (A, B, . . . ), such as 20 or more, the cost saving would be substantial.

Also, it makes the vending machine look less cluttered, as all, or most, of those lifting-arms 1a, 1b, . . . , 1f, are not present along the shelf front.

In FIG. 2 and FIG. 3, the shelves may be open-ended so as to avoid blocking the paths of the lifting-arms 1, 1a, . . . , 1f, during their swing-up motion. As depicted in FIG. 1, the lifting-arm 1 could swing through the shelf frame (FIG. 1(C)).

In this case, it may be preferable to let the lifting-arm swing around to a full circle.

However, the lifting-arm may be of a linear actuator type that travels back and forth, instead of swinging.

The shape of the lifting-arm may be of any shape, linear as shown in FIG. 1, or angled shape, etc., so long as it performs the lifting up function as desired.

FIG. 3 also shows items of different thickness (3a, 3b, . . . versus 6a, 6b, . . . ). As depicted in FIG. 4, there is a problem if the length of the lifting-arm 1 is the same. The lifting-arm 1 would lift up more than one item, if the item is thin, in its retrieval action.

If there are many lifting-arms 1, 1a, . . . , 1f, as in FIG. 2, the length can be made to fit to the thickness of the item in each vending column, A, B, C, . . . .

However, if one moveable lifting-arm 1 is to serve many vending columns as depicted in FIG. 3, the potential problem of lifting more than one item becomes real.

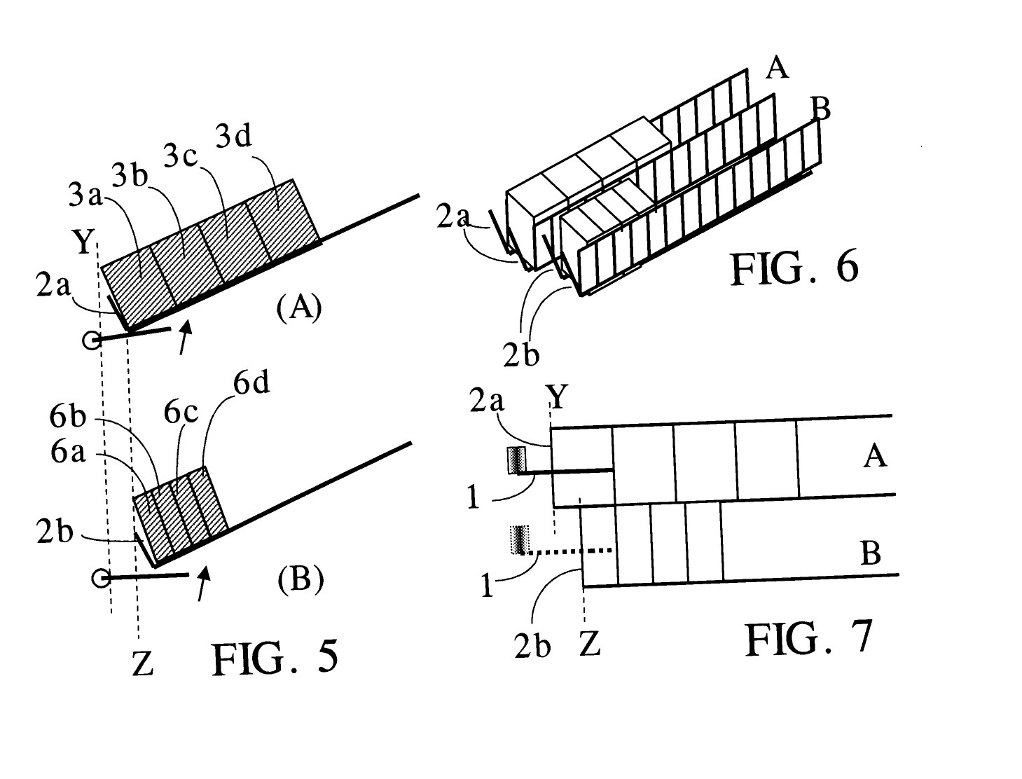

FIG. 5 shows a solution to the problem. As shown, the shelf-stop 2b of the column B is moved back with respect to the shelf-stop 2a of the column A, so that the traveling lifting-arm 1 reaches only first item 6a.

FIG. 6 shows the embodiments of FIG. 5 in a prospective view.

FIG. 7 shows the plan view of the embodiments of FIG. 5 and FIG. 6.

In FIG. 4 are shown ‘pushing-weights’ 7a and 7b, which increases the forwardly force. This pushing-weight 7a is needed especially when only one item is left on the shelf, since in this case there would be no force applied by the next item. For this reason, this pushing-weight is quite desirable.

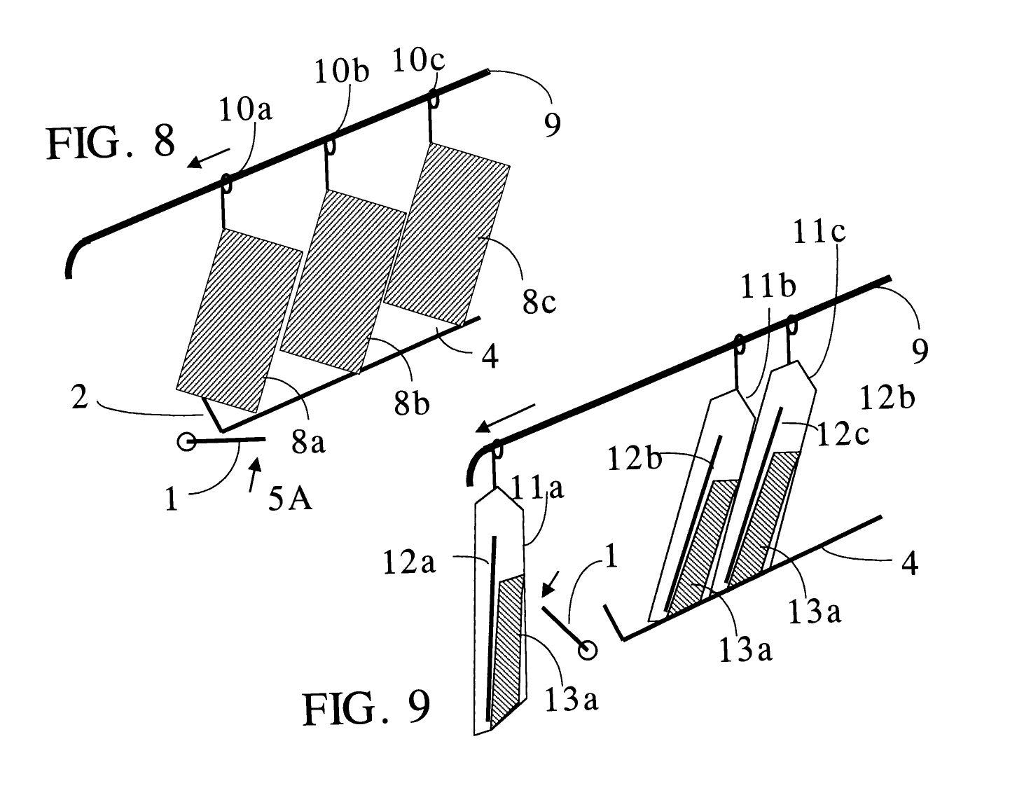

FIG. 8 shows oversized items 8a, 8b, and 8c. These items would take a substantial space in the vertical position if they stand upright. By tilting as shown in FIG. 8, the gap between the neighboring shelves can be reduced, saving the space.

Also, the oversized items require substantial height of the shelf-stop 2, since, otherwise, the items would topple over by themselves easily.

These problems are improved by providing a sliding support 9 that enhance the stability of the oversized items 8a, 8b, 8c, and allows them to take a slanted position as depicted in FIG. 8.

The items 8a, 8b, and 8c, may be connected to or be leaning on the supporting bar 9 through a loop or the likes 10a, 10b, and 10c.

The sliding support 9 may extend beyond the shelf front, as depicted in FIG. 8, so that an exiting item would ride on it and exit.

Such oversized items include a bag of charcoal, a jog of milk, 2-litre soda bottle, etc.

FIG. 9 shows another example where such a sliding support 9 can be helpful. This arrangement is useful for products that are small or thin. Examples include an ear-rings, a long-distance telephone card or gift card. This sort of items 12a is packaged in a substantially larger enclosure 11a.

A spacer 13a is added to the package in order to make sure that only one item is lifted up during the item-extracting process. FIG. 9 depicts the moment when the front-most item 11a is exiting.

FIG. 10 shows an oversized item 14a with a sliding rod 15a attached on the body.

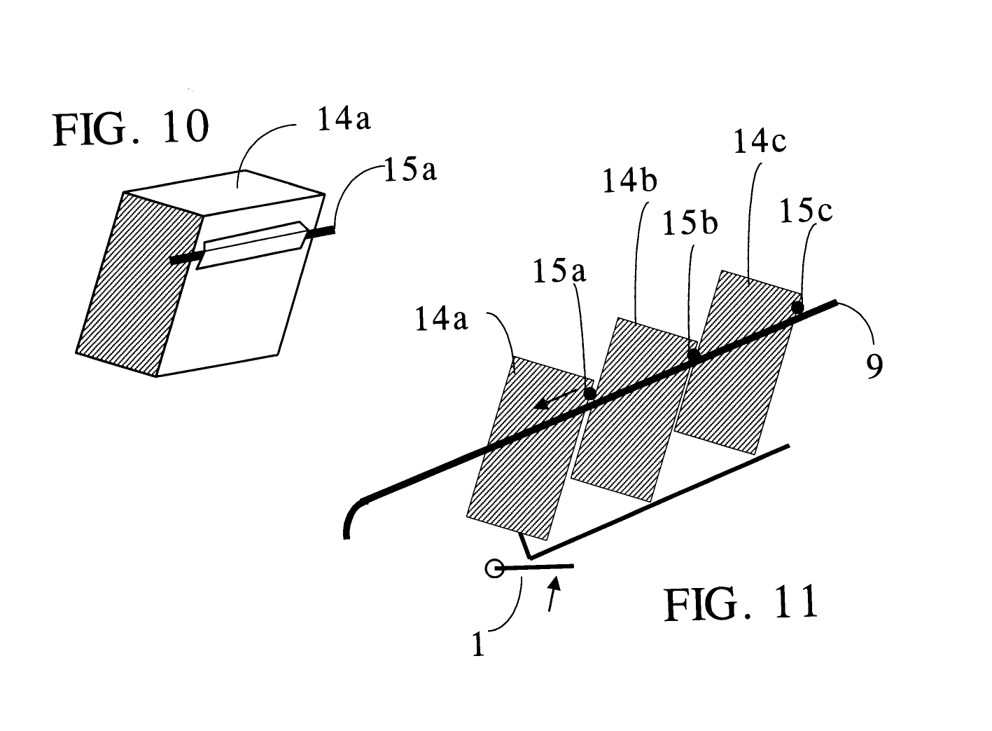

FIG. 11 shows the side view of the oversized items 14a of FIG. 10 packed along the support rail 9.

FIG. 12 shows a weight 17 with a wedged front 18. Oversized items 16a, 16b, 16c may take a stable leaning position by the virtue of the wedged front 18. Because the items are tilted backwardly, they take less space in the vertical direction.

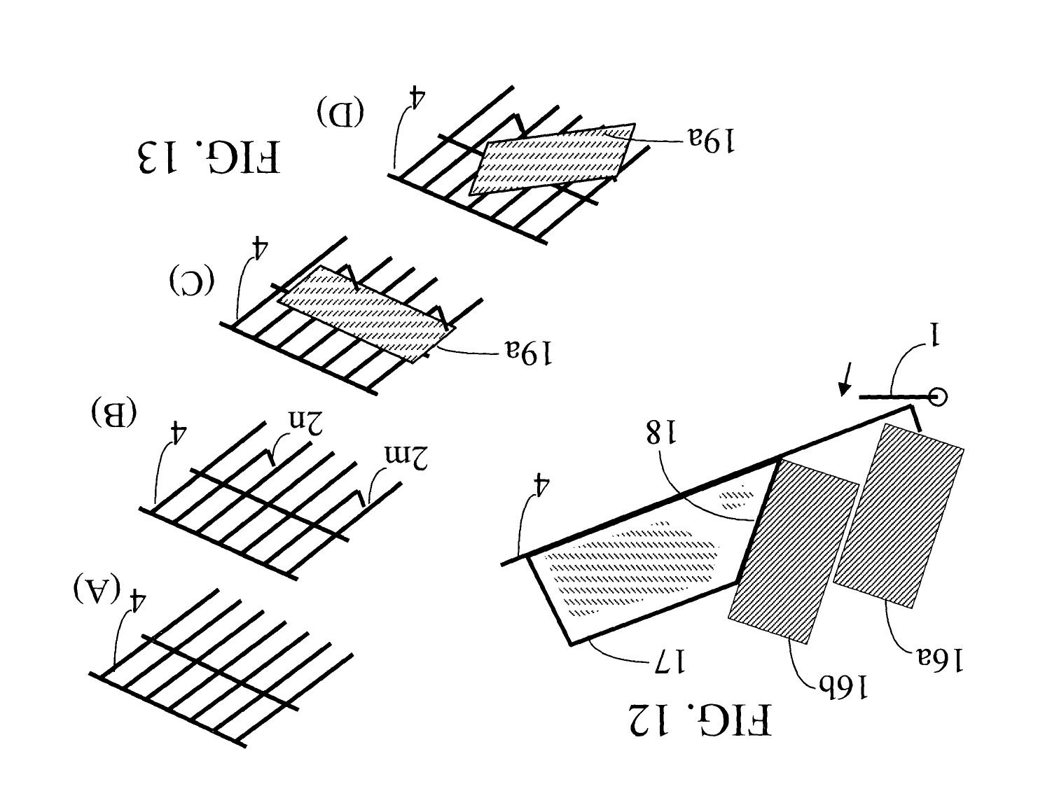

One economic way to fabricate the embodiments of the present invention is to modify a conventional shelf. As shown in FIG. 13(A), the end is preferably made open, and then, as shown in FIG. 13(B), some or all of the ends of the wire members are bent up to create the shelf-stop members such as 2m and 2n. When the item-to-be-extracted is long, such as in the case of candies or a bottle laid in a side way, it is helpful to have the shelf-stops positioned sparingly, as depicted in FIG. 13. Instead of bending up all the wires, only two wires are bent up to constitute the shelf-stop, as depicted as 2m and 2n in FIG. 13(B). When the elongated item 19a is lifted up by a lifting-arm 1 (not shown here to show other parts more clearly) over one or the other shelf-stop member, that is, 2m or 2n, the elongated item 19a loses its balance and slips down.

Obviously many modifications and variations of the present invention are possible in light of the above teachings. It is therefore to be understood that, within the scope of the appended claims, the invention may be practiced otherwise than as specifically described.

1. An item-extraction mechanism for a self-service merchandise vending machine comprising;
a lifting-arm (1),
a shelf-stop (2),
an item-to-be-extracted (3a),
and a shelf (4);
wherein the shelf-stop (2) is located at the front end of the shelf (4); the item-to-be extracted (3a) is located on the front-most part of the shelf (4) but behind the shelf-stop (2); and the lifting-arm (1) is located near the shelf-stop (2) in such a fashion that the lifting-arm (1) may be able to lift up the item-to-be-extracted (3a); whereby, in the item extraction process, the item-to-be-extracted (3a) is lifted up by the lifting-item (1) and is toppled over the shelf-stop (2) and drop.

2. The invention according to claim 1, wherein the item-to-be-extracted (3a) is under a forwardly pressure so that it is toppled over the shelf-stop (2) more readily during the item extraction process.

3. The invention according to claim 2, wherein the forwardly pressure is increased by a pushing-weight (7a).

4. The invention according to claim 3, wherein the pushing-weight (18) has a wedged front surface (18).

5. The invention according to claim 1, wherein the shelf (4) is tilted so as to exert a forwardly gravity force on the item-to-be-extracted (3a).

6. The invention according to claim 1, wherein the front of the shelf (4) is open-ended so that the lifting-arm (1) may swing through the shelf-stop (2).

7. The invention according to claim 1, wherein the lifting-arm (1) makes a 360 degree full circle in its item-extraction process.

8. The invention according to claim 1, wherein the item-to-be-extracted (3a) is a under-sized product enclosed in an enclosure (11a) that is large enough for a reliable extraction process.

9. The invention according to claim 1, wherein the item-to-be-extracted (3a) is accompanied by a spacer (12a) so as to ensure a reliable extraction process.

10. The invention according to claim 1, wherein the shelf-stop (2) is fabricated by bending up the ends of the wire members (2m, 2n) of a conventional shelf.

11. The invention according to claim 1, wherein the item-to-be-extracted (19a) is substantially elongated, and the shelf-stop (2) assigned to the elongated item-to-be-extracted (19a) comprises two upright members (2m, 2n) positioned close to the ends of the elongated item-to-be-extracted (19a).

12. An item-extraction mechanism for a self-service merchandise vending machine comprising;
a lifting-arm (1),
a shelf-stop (2),
an item-to-be-extracted (3a),
a shelf (4)
and a support rail (9);
wherein the shelf-stop (2) is located at the front end of the shelf (4); the item-to-be-extracted (3a) is located on the front-most part of the shelf (4) but behind the shelf-stop (2); the support rail (9) is positioned along the direction of the item extraction; the item-to-be-extracted (3a) leans on the support trail (9) to maintain a proper and stable orientation; and the lifting-arm (1) is located near the shelf-stop (2) in such a fashion that the lifting-arm (1) may be able to lift up the item-to-be-extracted (3a);
whereby, in the item extraction process, the item-to-be-extracted (3a) is lifted up by the lifting-item (1) and is toppled over the shelf-stop (2) and drop.

13. A self-service merchandise vending machine comprising an array of vending columns (A, B, . . . ) with one common lifting-arm (1);
each vending column comprising;
a shelf-stop (2),
an item-to-be-extracted (3a);
wherein the lifting-arm (1) is moveable from one vending column (A) to the next (B) across the display front; the shelf-stop (2) is located at the front end of the shelf (4); the item-to-be-extracted (3a) is located on the front-most part of the shelf (4) but behind the shelf-stop (2); and the lifting-arm (1) is located near the shelf-stop (2) in such a fashion that the lifting-arm (1) may be able to lift up the item-to-be-extracted (3a);
whereby, in the item extraction process, the lifting-arm (1) is moved to a desired vending column (A), and then the item-to-be-extracted (3a) is lifted up by the lifting-arm (1) and is toppled over the shelf-stop (2) and drop.

14. The invention according to claim 13, wherein the shelf-stop (2a) of a vending column (B) with thinner items (6a, 6b, . . . ) is located behind the shelf-stop (2b) of other column (A) with thicker items (3a, 3b, . . . ) so that the lifting-rod (1) reaches only the front-most item in the item extraction process regardless of the thickness of the items to be extracted.

15. The invention according to claim 13, wherein the vending columns (A, B, . . . ) are separated by column dividers (5, 5a, 5b, . . . ).
